(19) United States
(12) Patent Application Publication
(10) Pub. No.: US 2008/0084393 A1
(43) Pub. Date: Apr. 10, 2008

(54) Device for inputting information

(75) Inventors: Eung-Cheon Kang, Hwaseong-si (KR); Ho-Chul Joung, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/905,965

(22) Filed: Oct. 5, 2007

(30) Foreign Application Priority Data
Oct. 10, 2006 (KR) 10-2006-0098535

(51) Int. Cl. G06F 3/033

(52) U.S. Cl. 345/166

(57) ABSTRACT

In an information input device, which includes: a flat main body; a rotary input module that includes a maneuver part, which is rotatably supported by a support part, and a detector part, which generates signals in correspondence to the rotation of the maneuver part, where the maneuver part is exposed at one side of the main body; an optical module installed on the board such that the optical module is exposed at the other side of the main body, where the optical module generates signals in correspondence with the movement of the main body; and a memory device housed within the main body, a HDD may be mounted in a slim type mouse, which has a small volume for convenient use and portability, so that an effect comparable to using a portable auxiliary memory device can be obtained simply by connecting the mouse.

### CROSS-REFERENCE TO RELATED APPLICATIONS

This application claims the benefit of Korean Patent Application No. 10-2006-0098535 filed with the Korean Intellectual Property Office on Oct. 10, 2006, the disclosure of which is incorporated herein by reference in its entirety.

### BACKGROUND

1. Technical Field

The present invention relates to a device for inputting information.

2. Description of the Related Art

An information input device, such as a mouse, is widely being used as hardware for inputting information in electronic apparatus such as personal computers and laptops, etc. In particular, with the use of Windows from Microsoft Corporation as the OS (operating system) in computers, the mouse has rapidly been popularized as an inputting means besides the keyboard.

FIG. 1 is a perspective view of a mouse, an example of a conventional information input device. Referring to FIG. 1, a conventional mouse includes a main frame 110 that has a flat bottom surface, a grip part 120 formed at the upper side of the main frame 110 that allows gripping for a hand, buttons 130 formed at the front of the grip part 120 that can be pressed by a finger, etc., a sensor part formed at the lower side of the main frame 110 that recognizes position changes of the mouse 100, and a cable 150 for connecting the mouse 100 to an electronic apparatus such as a personal computer. A wheel 160 is formed between the buttons 130.

The user moves the mouse 100 two-dimensionally over a mouse pad, to move a cursor, etc., to a desired position, and then clicks a button 130 to run a corresponding icon, etc. Also, to move the screen on the display of the computer up or down, the wheel 160 is rotated forward or backward with respect to the user.

However, as the conventional information input device has a convex shape for easy holding by the user, it is inevitably given a large volume. Also, since the wheel 160, one of the inputting means, is positioned perpendicularly to the work surface, such as the pad, there is a limit to how much the volume of the information input device can be reduced.

Also, there is a limit to how slim the conventional mouse can be made, due to the wheel, positioned vertically with respect to the work plane, and the thick optical module, etc. Furthermore, due to the increasing capacities of information, a PC or laptop may require additional portable auxiliary memory devices, besides a mouse, so that the connection between the devices is made complicated and there is poor portability.

In other words, due to the increased capacities of information, the existing memory was not sufficient to obviate the need for portable auxiliary memory devices. In particular, portable information devices, such as laptop computers, require portable auxiliary memory devices for satisfactory use of high-capacity information.

### SUMMARY

An aspect of the invention is to provide a device for inputting information, which has a small volume for convenient use and portability, and in which a portable auxiliary memory device is installed for greater convenience in transferring, processing, and storing information of high capacity.

One aspect of the invention provides a device for inputting information, which includes: a flat main body; a rotary input module that includes a maneuver part, which is rotatably supported by a support part, and a detector part, which generates signals in correspondence to the rotation of the maneuver part, where the maneuver part is exposed at one side of the main body; an optical module installed on the board such that the optical module is exposed at the other side of the main body, where the optical module generates signals in correspondence with the movement of the main body; and a memory device housed within the main body. The memory device may include a hard disk drive (HDD).

The thickness of the main body may correspond with the maximum value among the thicknesses of the rotary input module, the optical module, and the memory device.

The information input device may be connected to an external device and may further include a signal transmitter part, which transmits signals generated from any one or more of the detector part, the optical module, and the memory device to the external device, while the signal transmitter part may include a conductor, which is connected to one or more of the detector part, optical module, and memory device, and a USB connector, which is connected to the external device.

The data processed in the external device may be transmitted through the signal transmitter part to be recorded in the memory device, and a supplementary switch, which controls the operation of the memory device, may be coupled to the main body.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a mouse, an example of a conventional information input device.

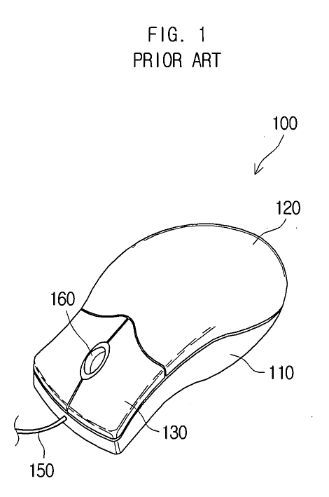

FIG. 2 is a perspective view of an information input device according to an embodiment of the present invention.

FIG. 3 is a perspective view of an information input device, with the upper case removed, according to an embodiment of the present invention.

FIG. 4 is a perspective view of the reverse side of an information input device according to an embodiment of the present invention.

FIG. 5 is a drawing illustrating an information input device in use according to an embodiment of the present invention.

### DETAILED DESCRIPTION

The device for inputting information according to certain embodiments of the invention will be described below in more detail with reference to the accompanying drawings, in which those components are rendered the same reference numeral that are the same or are in correspondence, regardless of the figure number, and redundant explanations are omitted.

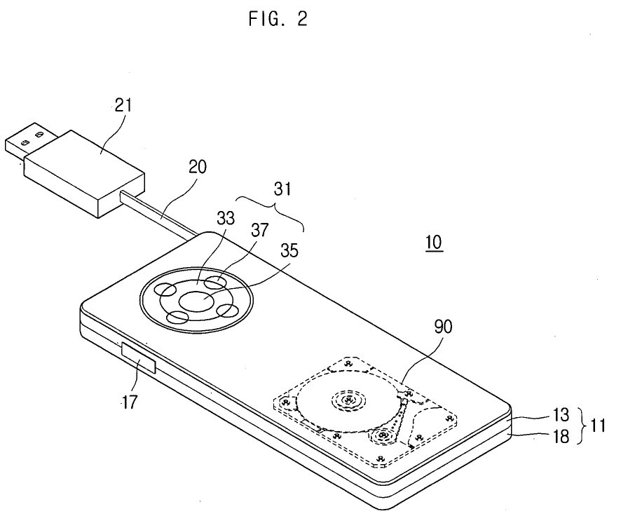

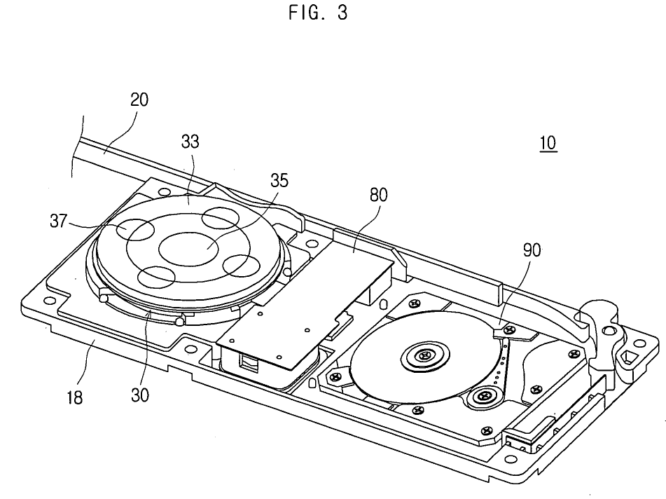

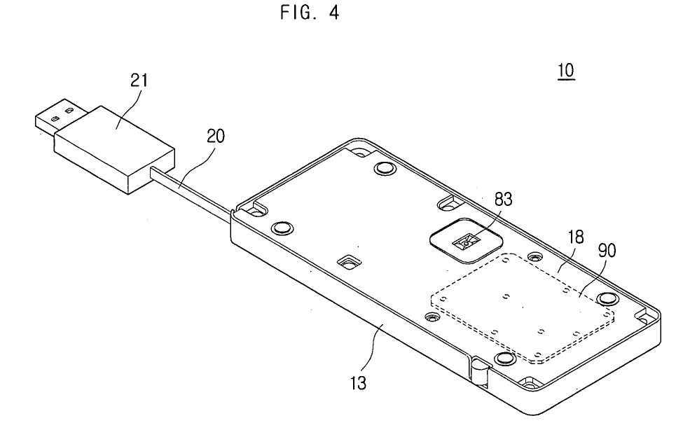

FIG. 2 is a perspective view of an information input device according to an embodiment of the present invention, FIG. 3 is a perspective view of an information input device, with the upper case removed, according to an embodiment of the present invention, and FIG. 4 is a perspective view of the reverse side of an information input device according to an embodiment of the present invention. In FIGS. 2 to 4 are illustrated a mouse 10, a main body 11, an upper case 13, a supplementary switch 17, a lower case 18, a signal transmitter part 20, a USB connector 21, a rotary input module 30, a wheel 33, a center key 35, side keys 37, an optical module 80, a lens 83, and a HDD 90.

This embodiment illustrates a slim-type mouse 10, to which an rotary input module 30 infinitely rotatable in a horizontal direction is applied, in which an auxiliary memory device is mounted for high-capacity information processing. Thus, just by connecting a mouse 10 according to the present embodiment, an auxiliary memory device for high-capacity information processing may be used conveniently without having to use a separate device, whereby the storage, transfer, and processing of information of high capacity are facilitated.

In this embodiment, a mouse 10 is used as an example of an information inputting device, and a HDD (hard disk drive) 90 is used as an example of a memory device. The mouse 110 illustrated in FIGS. 2 to 4 has a HDD 90 additionally mounted to a basic structure composed of a rotary input module 30 and an optical module 80 mounted in a main body 11 having a flat shape.

As illustrated in FIG. 2, the mouse 10 according to this embodiment may be shaped substantially as a flat cuboid, with the main body 11 composed basically of an upper case 13 and a lower case 18. Forming the main body 11 to have this flat shape may allow convenient portability, because when carrying the mouse 10, it may readily be inserted into the main body of a laptop computer, etc. The main body 11 may be formed to have a small thickness for even more convenient portability, and for a more desirable appearance, deco spin processing, etc., may be applied to the upper surface of the upper case 13, etc. The length and width of the main body 11 may be formed to allow convenient gripping and easy carrying by the user, and it is to be appreciated that the shape of the main body 11 is obviously not limited to a cuboidal shape, and that any shape may just as well be used that allows easy carrying and convenient use.

The rotary input module 30 is a component which may serve to generate signals corresponding to a clicking, dragging, or scrolling action, etc., taken by the mouse 10, and may be composed of a maneuver part, which is rotatably supported by a support part, and a detector part, which generates signals in correspondence to the rotation of the maneuver part. In this embodiment, the rotary input module 30 is applied, which is rotatable in a horizontal direction, instead of the conventional wheel, which is coupled in a vertical direction with respect to the work plane. This may be seen as the “horizontal rotation wheel key”, used in mobile phones, etc., applied to a mouse 10.

In a portion of the upper case 13, the maneuver part 31 of the rotary input module 30 may be exposed to the exterior, where a user may turn the wheel 33 or press the center key 35 formed in the center of the wheel 33, while holding the main body 11, using an index finger, etc., to input information. As illustrated in FIG. 3, the rotary input module 30, the optical module 80, and the HDD 90 may be sequentially coupled to the lower case 18, which couples with the upper case 13 to form an internal space.

A supplementary switch 17 may be formed on the side of the main body 11, where a user, while holding the mouse 10, may press the supplementary switch 17 using a thumb, etc., to input information. While the external device can be made to automatically recognize the HDD 90 with only the connecting of the mouse 10, the supplementary switch 17 may act as a “switch” that controls whether or not the HDD 90 is to be recognized or not to be recognized according to the discretion of the user, as will be described in more detail later.

A signal transmitter part 20 may be equipped at the front of the main body 11 that connects the mouse 10 with an external device (not shown). This may be a cable or a wire that electrically connects the various electronic modules mounted inside the mouse 10 with the external device, as described in FIG. 2, or may be implemented as a wireless transceiver module not illustrated. The composition for mounting a wireless transceiver module in a mouse 10 to communicate wirelessly with an external device is already widely known, and thus will not presented in further detail.

By way of the signal transmitter part 20, signals generated by the rotary input module 30 and the optical module 80 mounted in the mouse 10 can be transmitted to an external device (not shown). Thus, at one end portion of the signal transmitter part 20 there may be a terminal, such as a USB connector 21, that connects to the external device.

The optical module 80, which may be mounted inside the main body 11 to generate signals in correspondence with the movement of the main body 11, may be exposed towards the bottom surface of the main body 11. That is, as the main body 11 of the mouse 10 is moved by the user's maneuvering, the optical module 80 may generate corresponding signals and transfer the signals through the signal transmitter part 20 to an external device. The optical module 80, as illustrated in FIG. 4, may have a light source, such as an LED, that emits light through a lens 83, and a sensor that recognizes the light reflected from the bottom surface to sense the movement distance and direction of the main body 11, and may transmit corresponding signals to the external device, whereby a pointer may be moved to a desired position on a display installed on the external device. The specific composition and operation method of the optical module 80 are of common knowledge in the relevant field of art, and thus will not be provided in further detail. In the mouse 10 according to the present embodiment, an optical module 80 having a small thickness may be used to implement a “slim mouse”.

The main body 11 of a mouse 10 based on the present embodiment may be formed with a size and shape suitable for housing the HDD 90 within. Of course, at the position where the HDD 90 is to be mounted, those elements that connect the HDD 90 and the external device may have to be added, such as electrical contacts, connectors, and/or electrical circuits for signal processing, in correspondence with the electrical contacts of the HDD 90.

The mouse 10 according to the present embodiment has the rotary input module 30, optical module 80, and HDD 90 mounted inside, and in order to implement a “slim mouse”, each module may be arranged on the lower case 18 without overlapping. Therefore, the thickness of the main body 11 may be determined by whichever has the greatest thickness from among the rotary input module 30, optical module 80, and HDD 90. Thus, as described above, it may be desirable that the optical module 80 mounted be of a thickness no greater than those of the other modules.

Conversely, in certain situations, such as those cases where the size of the high-capacity HDD 90 is so great that it amounts to the size of the entire mouse 10, such that there is difficulty in arranging the rotary input module 30 and optical module 80 side by side, it is possible to arrange the rotary input module 30 and/or optical module 80 over and/or below the HDD 90. It is to be appreciated that, even in these situations, the positions may be selected such that the rotary input module 30 is exposed at the upper portion of the mouse 10 and the lens 83 of the optical module 80 is exposed at the lower portion of the mouse 10.

The rotary input module 30 may be secured horizontally to the lower case 18 of the main body 11, with the wheel 33 exposed through the upper case 13 to the exterior. As the user rotates the wheel 33 of the rotary input module 30, a function may be activated similar to the function of the wheel mounted vertically in a conventional mouse, etc. Whereas the conventional mouse wheel is mounted vertically with respect to the bottom surface, the rotary input module 30 based on the present embodiment is mounted horizontally with respect to the bottom surface, so that it is possible to reduce the volume. By rotating the wheel 33 clockwise or counterclockwise, a “scroll” function may be performed, such as moving the screen up or down in the display of an external device.

In a rotary input module 30 according to this embodiment, the element for detecting changes in polarity of the magnet rotating together with the wheel 33 may be a Hall sensor (Hall effect sensor), which is a silicon semiconductor using the effect of electromotive forces generated when electrons experience the Lorentz force in a magnetic field and their direction is curved. The Hall sensors 69 may generate electromotive forces that are proportional to the rotation of the magnet attached to the wheel 33, which may be transferred via the board 65 to an external control device (not shown).

Of course, the detection element is not necessarily limited to a Hall sensor, and any element may be used which is able to detect the rotation of the magnet. For example, an MR (magneto-resistive) sensor or a GMR (giant magneto-resistive) sensor may be used for the detection element. An MR sensor or a GMR sensor is an element of which the resistance value is changed according to changes in the magnetic field, and utilizes the property that electromagnetic forces curve and elongate the carrier path in a solid to change the resistance. Not only are MR sensors or GMR sensors small in size with high signal levels, but also they have excellent sensitivity to allow operation in low-level magnetic fields, and they are also superb in terms of temperature stability.

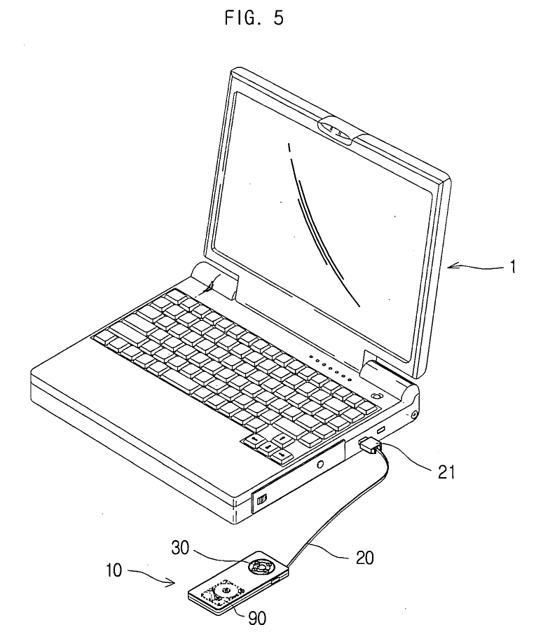

FIG. 5 is a drawing illustrating an information input device in use according to an embodiment of the present invention. In FIG. 5 are illustrated an external device 1, a mouse 10, a signal transmitter part 20, a USB connector 21, a rotary input module 30, and a HDD 90.

A mouse 10 based on this embodiment may be connected to an external device 1, such as a PC or a laptop computer, to be used not only as a mouse 10 but also as a portable auxiliary memory device, where the signal transmitter part 20 described earlier may serve to transmit signals generated from the detector part of the rotary input module 30, the optical module 80, and the HDD 90 to the PC. Also, data stored in or processed by the external device 1, such as a PC, etc., may be transmitted through the signal transmitter part 20 to be recorded in the HDD 90 installed in the mouse 10.

Thus, the signal transmitter part 20 according to this embodiment may be composed of a conductor, such as a cable, wire, connector, or electrical contacts, etc., that is connected with the detector part, optical module 80, and HDD 90 inside the mouse 10, a cable connected to the conductor or a wireless transceiver module, and a terminal, such as a USB connector 21, etc., for connecting with the PC.

As illustrated in FIG. 5, at one end of the signal transmitter part 20 of the mouse 10 according to this embodiment, there may be a USB connector 21 that can be coupled to a USB terminal on the external device 1. Thus, if the mouse 10 is connected to the USB terminal of a PC, etc., the mouse 10 may be automatically recognized by the PNP (plug and play) function, along with the HDD 90, so that the mouse 10 according to this embodiment may be used as an externally connected auxiliary memory device.

However, it is to be appreciated that the mouse 10 based on this embodiment does not necessarily have to be connected to a USB terminal, and may just as well be connected to any other type of terminal that can recognize the mouse 10. Also, the mouse 10 according to the present embodiment may be connected to the external device 1 with a special driver installed in the external device 1 to allow use as a mouse 10 and an auxiliary memory device.

Besides having the mouse 10 and HDD 90 according to this embodiment recognized using the PNP function of a PC, or using a special driver installed, it is possible to control whether or not the HDD 90 is to be operated using the supplementary switch 17 formed on the main body 11.

To be more specific, when the mouse 10 is connected to the external device 1 and the supplementary switch 17 formed on the main body 11 is pressed, the HDD 90 can be made to operate, such as by supplying power to the HDD 90, so that the HDD 90 is recognized by the PC. Because the HDD 90 may cause relatively larger power consumption, louder noise, and more heat emission, etc., the supplementary switch 17 may be installed which turns the HDD 90 on or off, so that the user can choose to operate the HDD 90 based on this embodiment as an auxiliary memory device only when desired.

According to certain embodiments of the invention as set forth above, a HDD may be mounted in a slim type mouse, which has a small volume for convenient use and portability, so that greater convenience is provided, as an effect comparable to using a portable auxiliary memory device can be obtained simply by connecting the mouse to a PC or laptop.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An information input device comprising:
a flat main body;
a rotary input module comprising a maneuver part rotatably supported by a support part, and a detector part configured to generate a signal in correspondence to a rotation of the maneuver part, the maneuver part being exposed at one side of the main body;
an optical module installed on the board such that the optical module is exposed at the other side of the main body, the optical module configured to generate a signal in correspondence with a movement of the main body; and
a memory device housed within the main body.

2. The information input device of claim 1, wherein a thickness of the main body is in correspondence with a maximum value among thicknesses of the rotary input module or the optical module or the memory device.

3. The information input device of claim 1, wherein the memory device comprises a hard disk drive (HDD).

4. The information input device of claim 1 connected to an external device, and further comprising a signal transmitter part configured to transmit a signal generated from any one or more of the detector part or the optical module or the memory device to the external device.

5. The information input device of claim 4, wherein the signal transmitter part comprises a conductor connected to one or more of the detector part or the optical module or the memory device, and a USB connector connected to the external device.

6. The information input device of claim 4, wherein data processed in the external device is transmitted through the signal transmitter part to the memory device.

7. The information input device of claim 1, wherein a supplementary switch is coupled to the main body, the supplementary switch configured to control an operation of the memory device.
